(19) United States
(12) Patent Application Publication
(10) Pub. No.: US 2005/0076389 A1
(43) Pub. Date: Apr. 7, 2005

(54) Apparatus for displaying program information for a video display appliance and method thereof

(75) Inventor: Su Jin Lee, Suk-gu (KR)

Correspondence Address: FLESHNER & KIM, LLP, P.O. BOX 221200, CHANTILLY, VA, 20153, US

(73) Assignee: LG Electronics Inc.

(21) Appl. No.: 10/953,179

(22) Filed: Sep. 30, 2004

(30) Foreign Application Priority Data
Oct. 2, 2003 (KR) 10-2003-0068921

(51) Int. Cl. H04N 7/173; G06F 13/00; H04N 5/445; G06F 3/00; H04N 7/08; H04N 7/16

(52) U.S. Cl. 725/131; 725/139; 725/151; 725/40; 348/563; 348/473

(57) ABSTRACT

An apparatus for displaying program information for a video display appliance and the method thereof that can display the program information according to a condition set by a user without any separate manipulation if the user sets an automatic program information display function. The apparatus includes a demultiplexer for separating a video signal, an audio signal and additional information from a received broadcasting signal, a user interface for providing an interface with a user, a memory for storing the program information included in the additional information separated by the demultiplexer and information that is set by the user and is inputted through the user interface, a program information generating unit for generating a signal for displaying the program information, a switching unit for selectively outputting an output of the program information generating unit, a video signal processing unit for processing the output of the program information generating unit outputted through the switching unit so as to display the output of the program information generating unit, and a control unit for controlling the program information generating unit and the switching unit so as to display the program information according to the information set by the user.

### BACKGROUND OF THE INVENTION

1. Field of the Invention

The present invention relates generally to a video display appliance, and more particularly, to an apparatus for displaying program information for a video display appliance and a method thereof that can receive and display the program information.

2. Description of the Related Art

Generally, a video display appliance is an appliance for selecting and displaying on a screen broadcasting signals transmitted from broadcasting stations in accordance with a user's selection. With the development of multimedia technology, the video display appliance has been gradually changing from an analog type to a digital type appliance,

Particularly, the digital type video display appliance provides various kinds of additional services such as home shopping, electronic newspaper, stock information, etc., which cannot be received through the existing analog type video display appliance and is capable of providing more broadcasting channels due to an efficient use of the bandwidth.

Following this trend, a standard guide to an interactive service such as an on-line game and a custom video service has now been established, and also manufacturers' technical research in developing an interface between a user and a custom service is actively progressing.

Accordingly, in the case of a video display appliance or an Internet TV (television receiver) currently being developed a GUI (Graphic User Interface) similar to a personal computer is available.

In this case, an electric program guide (hereinafter referred to as “program information”), which is guide information about broadcasting programs in the form of a graphic user interface, displays programs of respective broadcasting stations by dates and times desired by the user, and this service function is in a field requiring great technical development in order to increase tho convenience for the user to cope with the complexity and variety of the digital channels.

Hereinafter, a related-art apparatus for displaying program information for a video display appliance and a method thereof will be explained with reference to the accompanying drawings.

FIG. 1 is a block diagram illustrating a related-art apparatus for displaying program information for a video display appliance, and FIG. 2 is a flowchart illustrating the method of displaying program information for a video display appliance.

As shown in FIG. 1, the related-art apparatus for displaying program information for a video display appliance includes a tuner 11 for selecting a broadcasting signal, a demultiplexer 12 for demultiplexing the broadcasting signal selected through the tuner 11, i.e., a transport stream multiplexed in time, a video signal processing unit 13 for processing the broadcasting information demultiplexed by the demultiplexer 12 to display the broadcasting signal on a screen, a program information generating unit 14 for constructing a program guide view in the form of an on-screen display (OSD) using the program information, a switching unit 15 for switching an output of the video signal processing unit 13 and an output of the program information generating unit 14, a display unit 16 for displaying an output of the switching unit 15 on the screen, a memory unit 17, a control unit 18 for controlling the whole operation of the appliance, storing program guide view constituent information among outputs of the demultiplexer 12 in the memory unit 17, and reading the program guide view constituent information stored in the memory 17 according to a user's program guide view request command to transmit the readout program guide view constituent information to the program information generating unit 14, and a key input unit 19 for receiving a user's input of the program guide view request command and various kinds of operation-related commands.

Now, a related-art method of displaying program information for a video display appliance will be explained.

First, the transport stream selected by tho tuner 11 is demultiplexed through the demultiplexer 12, and then separated into broadcasting information and additional information including program guide related information. The additional information including the program guide related information is stored in the corresponding memory of the memory unit 17 under the control of the control unit 18.

Then, the broadcasting information is processed through the video signal processing unit 13 so that it can be displayed on the screen, passes through the switching unit 15, and then is displayed on the screen through the display unit 16.

Meanwhile, if the user requests the program guide view output by manipulating the key input unit 19, i.e., a key of a remote controller or of a main body, the control unit 18 reads out the program guide view constituent information from the memory 17, and transmits the readout program guide view constituent information to the program information generating unit 14.

Then, the program information generating unit 14 OSD-processes the program guide view constituent information transmitted from the control unit 18, which passes through the switching unit 15, and then is displayed through the display unit 16.

Referring to FIG. 2, if the user inputs a power-on command, video and audio signals are outputted (steps S1 and S2).

Then, it is determined whether the program information mode is selected (step S3).

If it is determined that the program information mode is selected (step S3), the program information view is constructed and displayed (steps S4 and S5).

Meanwhile, if the user inputs a mode switching command, the output of the video and audio signals is maintained, and if a power-off command is inputted, the output of the video and audio signals is terminated (steps S6 and S7).

As described above, according to the related-art apparatus and method for displaying program information for a video display appliance, a user must select a program information mode if he/she desires to know the information on a specified program. However, since this information requires the user's manually setting the information, it causes the user inconvenience.

### SUMMARY OF THE INVENTION

The present invention is directed to an apparatus for displaying program information for a video display appliance and a method thereof that substantially obviates one or more problems due to limitations and disadvantages of the related art.

It is an object of the present invention to provide an apparatus for displaying program information for a video display appliance and the method thereof that can display the program information according to a condition set by a user without any separate manipulation if the user sets an automatic program information display function.

It is another object of the present invention to provide an apparatus for displaying program information for a video display appliance and a method thereof that can select and display only the program information desired by the user.

To achieve these objects and other advantages in accordance with the purpose of the invention, as embodied and broadly described herein, there is provided an apparatus for displaying program information for a video display appliance that receives a broadcasting signal including a video signal, an audio signal and additional information, comprising a demultiplexer for separating the video signal, the audio signal and the additional information from the broadcasting signal, a user interface for providing an interface with a user, a memory for storing the program information included in the additional information separated by the demultiplexer and information that is set by the user and is inputted through the user interface, a program information generating unit for generating a signal for displaying the program information, a switching unit for selectively outputting an output of the program information generating unit, a video signal processing unit for processing the output of the program information generating unit outputted through the switching unit so as to display the output of the program information generating unit, and a control unit for controlling the program information generating unit and the switching unit so as to display the program information according to the information set by the user.

According to another aspect of the present invention, there is provided a method of displaying program information for a video display appliance that receives a broadcasting signal including a video signal, an audio signal and additional information, comprising the steps of checking whether an automatic display of program information is set by a user, if it is checked that the automatic display of the program information is set by the user, storing the set information, and displaying the program information included in the additional information according to the information set by the user while the video signal and the audio signal are outputted.

Additional advantages, objects, and features of the invention will be act forth in part in the description which follows and in part will become apparent to those having ordinary skill in the art upon examination of the following or may be learned by practicing the invention. The objectives and other advantages of the invention may be realized and attained by the structure particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a related-art apparatus for displaying program information for a video display appliance.

FIG. 2 is a flowchart illustrating the method of displaying program information for a video display appliance.

FIG. 3 is a block diagram illustrating an apparatus for displaying program information for a video display appliance according to the present invention.

FIG. 4 is a block diagram illustrating a method of displaying program information for a video display appliance according to the present invention.

FIGS. 5a, 5b, 6a, 6b, and 7a to 7f are views illustrating examples of views displayed in accordance with the program information display method for a video display appliance according to the present invention.

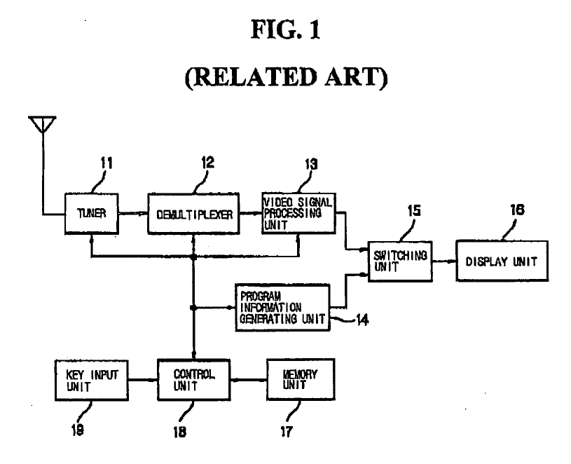

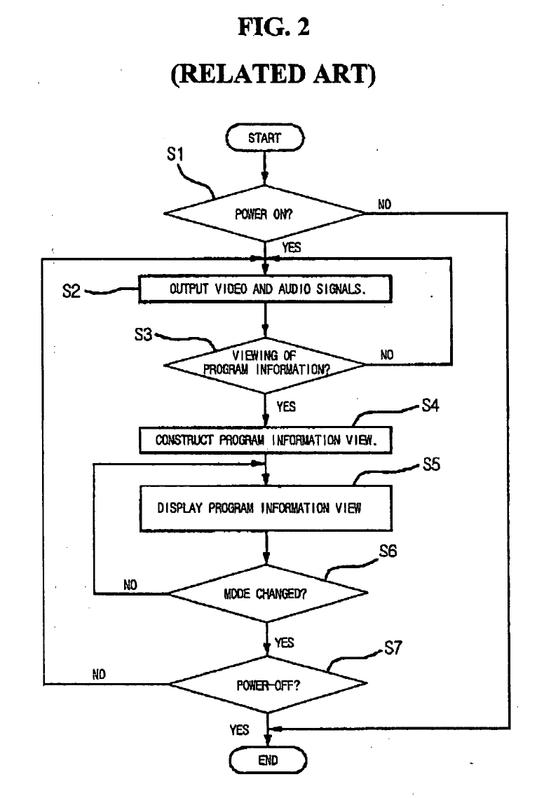

### DETAILED DESCRIPTION OF THE PREFERRED EMBODIMENT

Reference will now be made in detail to the preferred embodiment of the present invention, examples of which are illustrated in the accompanying drawings. Wherever possible, the same reference numbers will be used throughout the drawings to refer to the same or like parts.

Hereinafter, the apparatus for displaying program information for a video display appliance and the method thereof according to the present invention will be explained with reference to the accompanying drawings.

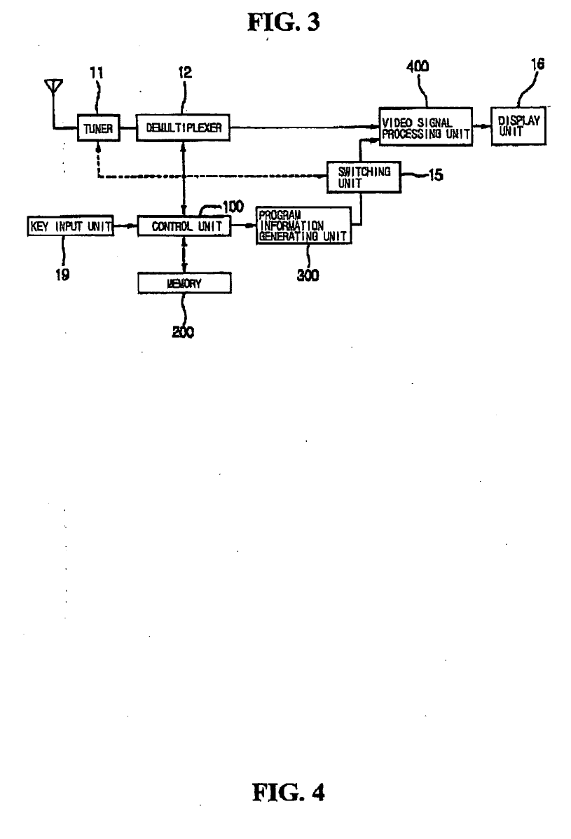

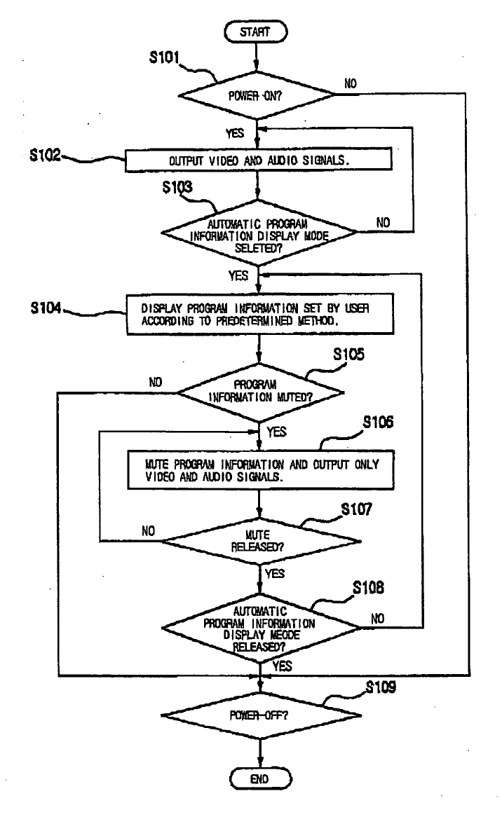

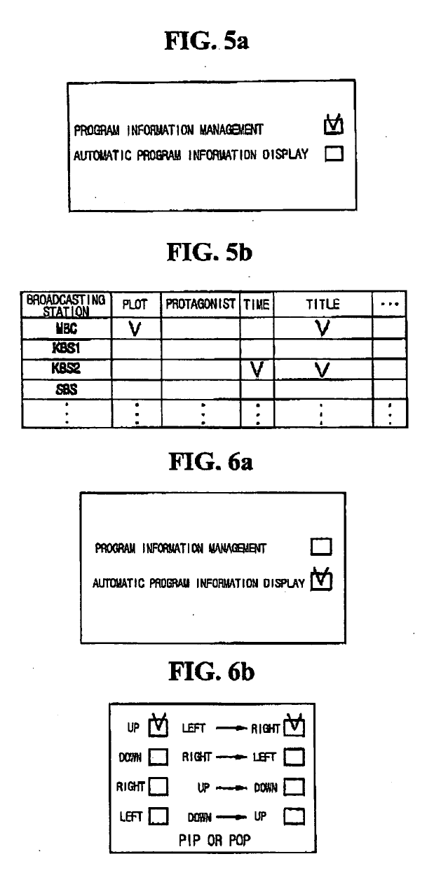

FIG. 3 is a block diagram illustrating an apparatus for displaying program information for a video display appliance according to the present invention. FIG. 4 is a block diagram illustrating a method of displaying program information for a video display appliance according to the present invention. FIGS. 5a and 5b are views illustrating examples of views displayed in accordance with the program information display method for a video display appliance according to the present invention.

As shown in FIG, 3, the apparatus for displaying program information for a video display appliance according to the present invention includes a tuner 11 for selecting a broadcasting signal, a demultiplexer 12 for demultiplexing the broadcasting signal selected through the tuner 11, i.e., a transport stream multiplexed in time, and separating the broadcasting signal into a video signal, an audio signal and additional information, a program information generating unit 300 for constructing a program guide view in the form of an OSD using the program information separated by the demultiplexer 12, a key input unit 19 for receiving a user's input of a request command and various kinds of operation-related commands, a memory 200 for storing program information and a condition that is set by a user and obtained from the additional information separated through the demultiplexer 12, a control unit 100 for performing a control operation so that the program information generated by the program information generating unit 300 and the video signal separated by the demultiplexer 12 are displayed together in accordance with the condition stored in the memory 200, a switching unit 15 for selectively outputting the program information generated by the program information generating unit 300 according to a control signal of the control unit 100, a video signal processing unit 400 for processing the program information outputted from the switching unit 15 to display the program information according to the user's request, and a display unit 16 for displaying the video signal processed by the video signal processing unit 400.

Now, the operation of the program information displaying apparatus for a video display appliance as constructed above according to the present invention will be explained.

First, a program information display condition desired by the user can be set through the key input unit 19.

At this time, an automatic program information mode may be selected so that the program information can be automatically turned on, and the program information to be displayed, display position, display method, etc., may be selected on a menu.

Here, the program information to be displayed may be any one of a plot of the program, a plot of the latest program, protagonist information, and a televising time, and the display position may be an upper or lower part of the display unit 16.

Also, the display method may be set to 'scroll for one line (or a plurality of lines) from right to left, and the color, size, font, etc., of the displayed characters can be set according to the user's taste.

Accordingly, while the user views the broadcasting signal received through the tuner 11, the corresponding program information can automatically be displayed in a determined position according to the condition set by the user.

With reference to FIG. 4, the program information displaying method for a video display appliance according to the present invention will be explained.

First, if the user inputs a power-on command, the video and audio signals are outputted (steps S101 and S102).

Then, it is determined whether the user has selected an automatic program information display mode (step S103).

If it is determined that the user has selected the automatic program information display mode (step S103), the program information of the outputted broadcasting signal is displayed according to the set condition (step S104).

Then, it is determined whether the user has selected to mute the program information (stop S105).

If it is determined that the user has selected to mute the program information at step S105, the program information being displayed is muted, and only the video and audio signals are outputted (step S106),

Meanwhile, if the user releases the mute, it is determined whether the user has released the automatic program information display mode (step S107 and S108).

If the user has not released the automatic program information display mode, then stop S104 is performed, while if the user releases the automatic program information display mode, the program information is continuously displayed until the power-off command is inputted.

As described above, according to the apparatus for displaying program information for a video display appliance and the method thereof, if the program information management is selected on the menu as shown in FIG. 5a, the program information is displayed as shown in FIG. 5b so that the user can select the desired program information. At this time, the program information that the user can select may be any one of either broadcasting station, plot, protagonist, time and title.

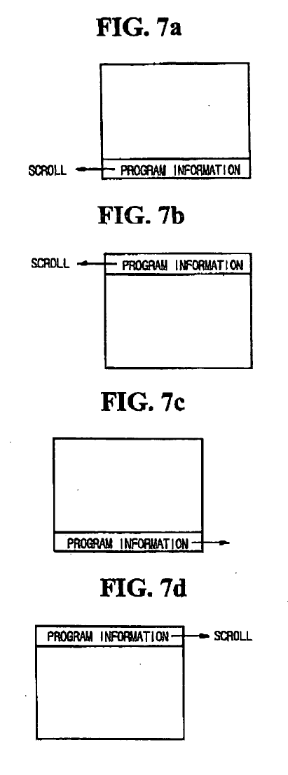

Meanwhile, if the automatic program information display mode is selected as shown in FIG. 6a, a menu for selecting the display position and the display direction is displayed as shown in FIG. 6b, and thus the user can select the desired display position and display direction with reference to the menu.

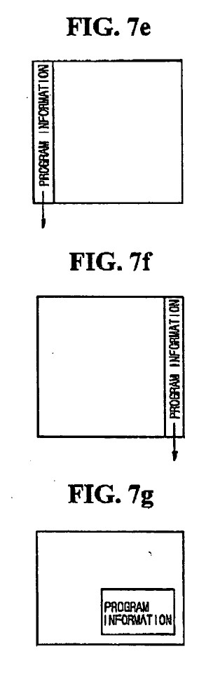

Specifically, the user may select the display position by marking one of up, down, left and right, and then select the display direction. The user may also select the scroll direction of the program information by marking one of left→right, right→left up→down and down→up, FIGS. 7a to 7f show examples of the scrolling program information displayed on the screen.

In addition, the scrolling program information may be displayed in a sub-picture region such as PIP or POP as shown in FIG. 7g.

As described above, the apparatus for displaying program information for a video display appliance and the method thereof according to the present invention have the following effects:

First, if the user selects the automatic program information display mode, the program information is scrolled on the screen along with the video signal in accordance with the display condition set by the user, and thus any inconvenience in use is minimized.

Second, the user can select only the desired program information to be displayed, and this improves the user's satisfaction

Third, the selection of color, size, font, etc., of the program information is possible and thus the program information which meets the user's tastes is displayed.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art

1. An apparatus for displaying program information for a video display appliance that receives a broadcasting signal including a video signal, an audio signal and additional information, the apparatus comprising:
a demultiplexer for separating the video signal, the audio signal and the additional information from the broadcasting signal;
a user interface for providing an interface with a user,
a memory for storing the program information included in the additional information separated by the demultiplexer and information that is set by the user and is inputted through the user interface;
a program information generating unit for generating a signal for displaying the program information, a switching unit for selectively outputting an output of the program information generating unit;
a video signal processing unit for processing the output of the program information generating unit outputted through the switching unit so as to display the output of the program information generating unit; and
a control unit for controlling the program information generating unit and the switching unit so as to display the program information according to the information set by the user.

2. The apparatus of claim 1, wherein the information set by the user includes one or more of a display mode, display information, a display position and a display method.

3. The apparatus of claim 2, wherein the display mode is a mode that the automatic program information display is turned on or off.

4. The apparatus of claim 2, wherein the display information is information selected to be displayed among the program information.

5. The apparatus of claim 2, wherein the display position is a position on a screen in which the program information is displayed.

6. The apparatus of claim 2, wherein tie display method indicate one or more of color, size and shape selected according to a user's taste when the program information is displayed.

7. The apparatus of claim 1, wherein the control unit removes the displayed program information according to a user's mute command inputted through the user interface,

8. The apparatus of claim 1, wherein the control unit operates to display the video signal separated from the broadcasting signal simultaneously with display of the program information.

9. The apparatus of claim 1, wherein the program information is displayed by an on-screen display.

10. A method of displaying program information for a video display appliance that receives a broadcasting signal including a video signal, an audio signal and additional information, comprising the steps of:
checking whether an automatic display of program information is set by a user;
if it is checked that the automatic display of the program information is set by the user, storing the set information; and
displaying the program information included in the additional information according to the information set by the user while the video signal and the audio signal are outputted.

11. The method of claim 10, wherein the set information the information includes one or more of a display mode, display information, a display position and a display method.

12. The method of claim 10 further comprising the steps of;
checking whether a user's mute command is inputted during the display of the program information according to the set information; and
if the mute command is inputted, removing the displayed program information,

13. The method of claim 10, wherein the displayed program information is a part of diverse program information selected by the user.

14. The method of claim 10, wherein the displayed program information includes a color, size, font, and the number of displayed lines according to a selection of the user.

15. The method of claim 10, wherein the displayed program information moves from left to right or from right to left of a screen according to a user's request

16. The method of claim 10, further comprising the step of if a mute of the program information is selected, outputting only the received video signal and audio signal without displaying the program information.

17. The method of claim 10, wherein the program information is displayed by an on-screen display.
